(19) United States
(12) Patent Application Publication
(10) Pub. No.: US 2004/0117612 A1
(43) Pub. Date: Jun. 17, 2004

(54) Method and communication system for providing a program element

(76) Inventor: Rainer Falk, Poing (DE)

Correspondence Address: STAAS & HALSEY LLP, SUITE 700, 1201 NEW YORK AVENUE, N.W., WASHINGTON, DC, 20005, US

(21) Appl. No.: 10/469,346

(22) PCT Filed: Jan. 25, 2002
(86) PCT No.: PCT/DE02/00267

(30) Foreign Application Priority Data
Feb. 28, 2001 (DE) 101 09 546.5

(51) Int. Cl. H04L 9/00

(52) U.S. Cl. 713/150

(57) ABSTRACT

A program element and an installation authorisation message containing a first piece of identification information, a second piece of identification information and a cryptographic value on at least these pieces of information are transferred to a second computer. Said first piece of identification information identifies the program element provided and the second piece of information identifies the second computer. The cryptographic value is created using the symmetrical secret key which is provided in the second computer and in an authentication unit. The symmetrical secret key is used to check the cryptographic value in the second computer.

The invention refers to a method and a communication system for providing a program element.

A conventional mobile radio telephone is controlled by using software. The software is normally loaded by the mobile radio telephone, installed there and implemented, in order to guarantee various functionalities in the mobile radio telephone.

The mobile radio telephone is thus, for example, controlled by software with regard to its radio communication properties (for example the frequency bands to be used, the transmitter power to be used and also the modulation method to be used) or other properties, such as the type of signaling, different strategies for frequency selection or different services, i.e. provided services.

To update the software or to load the software initially to the mobile radio telephone, to install it there and to implement it, it is necessary to transmit the software from a server computer to the mobile radio telephone.

Thus, the functionality of a mobile radio telephone, generally of a communication transmitter or a mobile radio terminal can be purposefully changed or expanded by loading appropriate software.

To prevent manipulation of the mobile radio telephone by unauthorized third parties, it must be guaranteed that only software is accepted by the mobile radio telephone and installed and implemented there that originates from an authorized, and therefore, reliable provider and for which it is guaranteed that the software has not been modified.

In this regard, it must be considered that software can be transmitted via any insecure channels, particularly via a radio channel, to the mobile radio telephone. Thus, for example, software can be obtained from a personal computer, a generally accessible computer that for example is installed at an airport or railway station or from a different mobile radio telephone, generally a different mobile radio terminal, generally via an air interface, i.e. via a radio link, or can be conducted via a connecting cable.

A method for reliable provision of software should advantageously not be dependent on special assumptions with regard to the type of distribution of the software.

To guarantee the integrity and secure verification of the origin of software, the digital signing of software with a secret key of the software provider using the principle of asymmetric encryption is known.

In this regard, the use of digital signed JAR files for JAVA is known, that are also used within the context of MExE (Mobile Station Application Execution Environment), an execution environment for using a mobile radio telephone, or to also use the techniques, such as Microsoft Authenticode™ and Netscape Object Signing™ used in the Internet.

With these known methods, a digital signature and sometimes other data that is used to check the digital signature, is added to the software. A digital signature uses the principle of asymmetric cryptography, with a private key and a corresponding pubic key that together form an asymmetric key pair being used.

Only the holder of a private cryptographic key can also create a valid digital signature, but anyone who knows public cryptographic keys matching the private cryptographic key can check the signature.

A certificate of the particular public cryptographic key is used to securely certify a link between the public cryptographic key and the name of the person or organization to which the public key belongs. In this way, it is guaranteed that the key pair used from the particular private cryptographic key and the public cryptographic key is reliable.

The use of asymmetric cryptography has the particular disadvantage that, for example, a high computing power is necessary to create a digital signature, which frequently means that special cryptographic co-processors are used in the particular computers creating the digital signature.

In particular, also the checking of the digital signature requires a very great computing effort because of the asymmetric cryptographic operations to be performed, that frequently considerably overload the computing power resources available at a mobile telecommunication terminal.

Furthermore, the sequence of certificates securing the public key used must be validated, which requires evaluation of the data contained in the certificates, such as for example checking the validity of the certificates used or taking into account restrictions that may be stipulated for the use of the particular certificates.

To check the validity of the certificates used, in addition to further signature checks, the loading of a Certificate Revocation List (CRL) or online checking of the status of the particular certificate, for example using the Online Certificate Status Protocol, is necessary.

Furthermore, the additional security information, i.e. the digital signature and the certificates belonging to the public keys lead to an increased amount of data to be transmitted (data volume).

In particular, when transmitting via a channel with only a small bandwidth available, such as for example when transmitting via a radio link, there is also the need to keep the amount of data as small as possible, particularly when transmitting a program, i.e. when transmitting software.

The object of the invention is therefore to provide a method and a communication system for providing a program element that achieves a reduced computation requirement and whereby the amount of data required for transmission of the security information is reduced.

This object is achieved by the method and communication system with the features in accordance with the independent patent claims.

With a method for providing a program element from a first computer for a second computer, the program element is transmitted from the first computer to the second computer. Furthermore, an installation authorization message is transmitted to the second computer, with the installation authorization message containing at least a first piece of identification information, a second piece of identification information and a cryptographic value that was formed at least by the first piece of identification information and the second piece of identification information. The provided program element is identified, preferably unambiguously, by the first piece of identification information. By means of the second piece of identification information, it is possible to clearly identify the second computer, also preferably unambiguously. The cryptographic value is formed by using a symmetrical secret key, with the symmetrical secret key being available in the second computer and also in an authentication unit, i.e. stored. By using the symmetrical secret key, the cryptographic value in the second computer is verified and, if the verification is successful and if in the installation authorization message the information is contained that the program element may be installed and/or executed, the program element is installed or executed in the second computer.

In this regard, it is to be noted that the information, particularly the relevant identification information, can be present explicitly and/or implicitly in each case. An example of the information being implicitly present can be seen in the use of the particular cryptographic key used that enables a suitable conclusion to be drawn regarding the particular instance using the key.

The first piece of identification information can be a hash value formed by the particular program element.

A communication system for providing a program element has

a first computer in which the program element is stored, with the first computer containing a transmitting unit for transmitting the program element to a second computer,

the second computer, with the second computer containing a receiving unit for receiving the program element and an installation authorization message,

with the installation authorization message containing at least the following information:

a first piece of identification information by means of which the provided program element is identified,

a second piece of identification information by means of which the second computer is identified,

a cryptographic value for at least the first piece of identification information and the second piece of identification information,

an authentication unit,

with a symmetrical secret key being stored in the second computer and in the authentication unit,

with the authentication unit having a unit forming the cryptographic value using the symmetrical secret key,

a with the second computer having a verification unit for verification of the cryptographic value using the symmetrical secret key, and

with the second computer having a decision unit that is set up in such a way that by using the installation authorization message and the verified cryptographic value, determines whether the program element may be installed in the second computer and executed.

The invention can be clearly seen in that a ticket is used in addition to the program element, that contains clear reliable security information for the identification of the provided program element and of the second computer, i.e. that computer on which the program element is to be installed or executed. The reliability of the identification information is achieved by the cryptographic value formed by the identification information using the symmetrical secret key.

The use of a symmetrical cryptographic method for forming the cryptographic value means that both the formation of the cryptographic value and also its verification are substantially simpler and can be executed with substantially less computing requirement. Furthermore, a substantially reduced amount of data is achieved for the installation authorization message compared with the amount of data normally required for the digital signature.

A program element in this context is any type of computer program or part of a computer program that can be performed by a processor. The performance of a computer program in this regard also means the interpretation of a computer program, for example the interpretation of a computer program in Java (Java-Bytecode) by means of a virtual machine.

Preferred developments of the invention are given in the related claims.

The cryptographic value can be a cryptographic hash value that is preferably formed in accordance with one of the following methods.

CBC-MAC using a known block cipher (e.g. DES, 3DES, AES, IDEA),

HMAC using a known hash function (e.g. MD5, SHA-1, RIPEMD, RIPEMD160), also designated as HMAC-MD5, HMAC-SHA1, HMAC-RIPEMD, HMAC-RIPEMD160,

HMAC using a known hash function with a shortened output (e.g. HMAC-MD5-80, HMAC-SHA1-80, HMAC-RIPEMD-80, HMAC-RIPEMD160-80 with an output shortened to 80 bits),

MAA,

RIPE-MAC,

MD5-MAC.

An overview of further methods that can also be used to form the cryptographic hash value is to be found in Alfred J. Menezes, Paul C. van Oorschot, Scott A. Vanstone, Handbook of Applied Cryptography, CRC Press Series on Discrete Mathematics and Its Applications, Series Editor: Kenneth H. Rosen, October 1996, CRC Press (Boca Raton, New York, London, Tokyo), ISBN 0849385237, p. 340-365) and in the Request for Comments No. 2104 of IETF (RFC 2104).

The cryptographic hash value is also designated a Message Authentication Code (MAC). The functions used to determine a message authentication code are also known as a “Keyed Hash Function”.

The use of standard cryptographic methods, that can normally be implemented not only in software but also in hardware, to form a hash value means that on the one hand the cryptographic hash value formed is very strong from a cryptographic point of view and therefore is very reliable, and on the other hand it can be formed very quickly, which means that the delay in forming the cryptographic value is kept low.

Additional information such as the following can also be added to the ticket, i.e. the installation authorization message.

The time point of creation, i.e. the generation of the installation authorization message.

Specification of a time period during which the installation authorization message is reliable, i.e. is valid.

Indication of the provider or distribution instance of the particular program element.

Indication of the security domain to which the loaded, i.e. provided, program element is to be assigned.

Indication of authorizations that are to be accorded to the program element during its execution by the second computer, particularly access rights to other wider program elements.

Indication of the demand for resources made by the provided program element during its execution and also for storing.

Indication that the program element is operable on a specified type (model) of a computer.

Indication that the program element is compatible with a further program element that is stored and operable on a second computer.

By using additional information of this kind, the flexibility of the method and thus the usability of the installation authorization message is substantially increased with regard to the provision of a program element.

The authentication unit can be contained in the first computer, in which case both the program element and also the installation authorization message is stored in the first computer.

Furthermore, a second computer with a database that also clearly functions as a program archive (download archive) can be provided that transmits the required program element to the first computer. In the download archive, the installation authorization messages that are in each case specific for a tuple of the following units:

authentication unit

second computer and

program element

can be stored in a communication network on the basis of the clear assignment of the symmetrical secret key to a second computer and to the particular authentication unit.

If the authentication unit is not contained in the first computer, then as an alternative it can be provided that the authentication unit has access to the download archive and from there loads previously stored installation authorization messages as required.

The authentication unit can, however, also itself form the cryptographic value by using the symmetrical secret key accessible to it.

The complete installation authorization message can itself also be secured by means of a cryptographic method, for example encrypted or signed by means of asymmetric or symmetric cryptography.

In accordance with an embodiment of the invention, it is provided that a request message is sent from the second computer to the authentication unit, by means of which an installation authorization message is requested for a first piece of information and a second piece of information contained in the request message.

In the authentication unit, it is determined for the program element belonging to the particular first piece of identification information and for the second computer corresponding to the second piece of identification information, whether the program element may be installed or executed. If this is the case, an installation authorization message is formed and sent to the second computer.

Different non-recurring values or the same non-recurring value can be contained both in the installation authorization message and also in the request message, in which case the degree of security with regard to the method is further increased.

The non-recurring value used can, for example, be a random number or a numerical value that can be specified in advance.

If the same non-recurring value is used in the installation authorization message and in the request message, the link between the request message and the installation authorization message is achieved, which further increases the degree of cryptographic security if the cryptographic value is additionally formed by means of the non-recurring value.

Furthermore, a cryptographic hash value can be formed by means of the program element itself and attached to the installation authorization message.

In accordance with a further embodiment of the invention, the second computer is a telecommunication terminal, for example a mobile telecommunication terminal, preferably a mobile radio communication terminal, i.e. a mobile radio telephone.

Exemplary embodiments of the invention are shown in the illustrations and explained in more detail. Identical elements in the illustrations are given the same reference characters.

The illustrations are as follows.

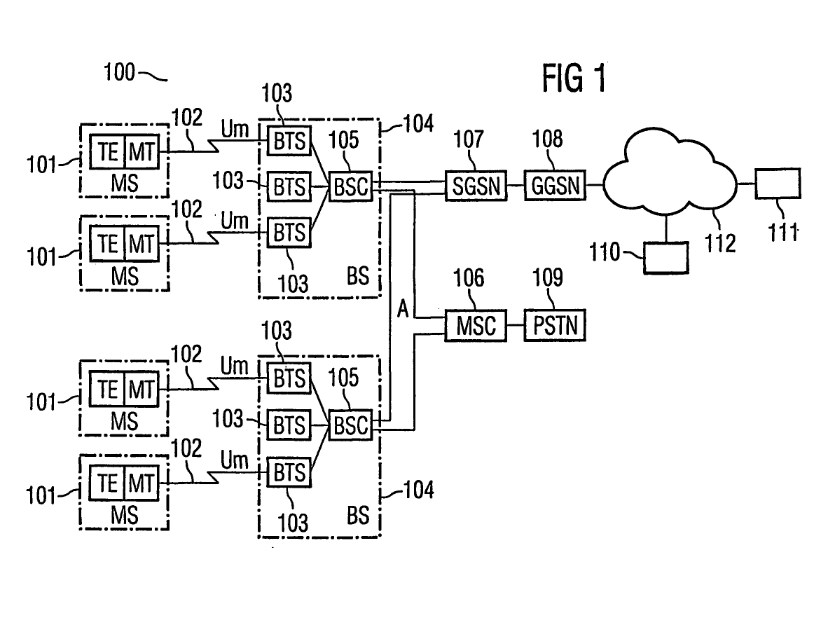

FIG. 1 A block diagram showing a communication system arranged in accordance with the GSM standard.

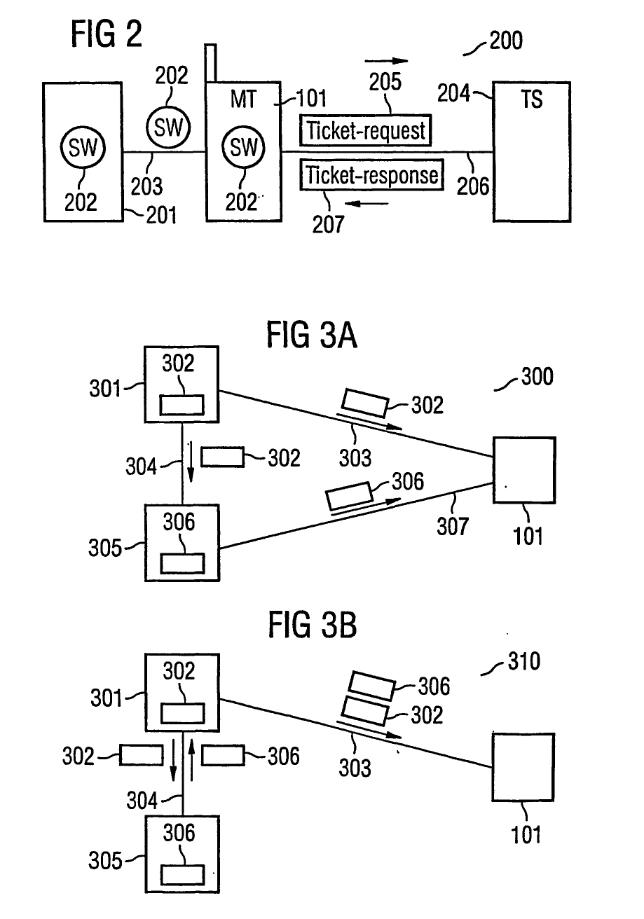

FIG. 2 A block diagram of a communication system in accordance with a first exemplary embodiment of the invention.

FIGS. 3a and 3b A block diagram for a communication system in accordance with alternative exemplary embodiments of the invention.

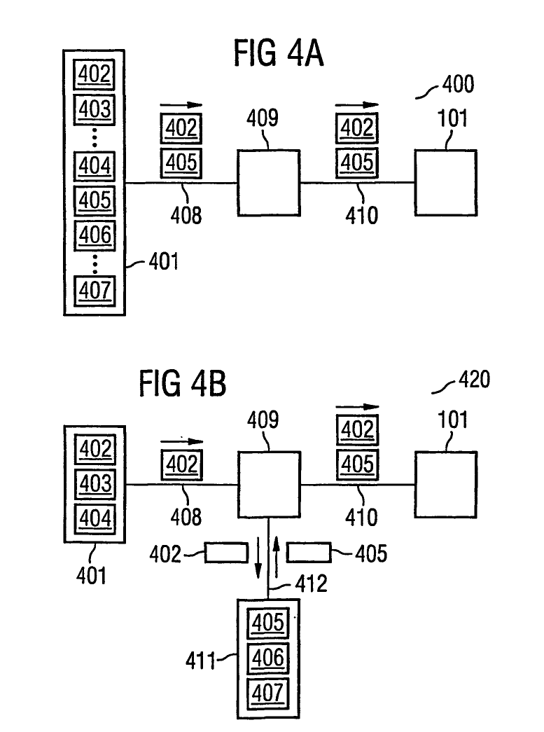

FIGS. 4a to 4c A block diagram of a communication system in accordance with further exemplary embodiments of the invention.

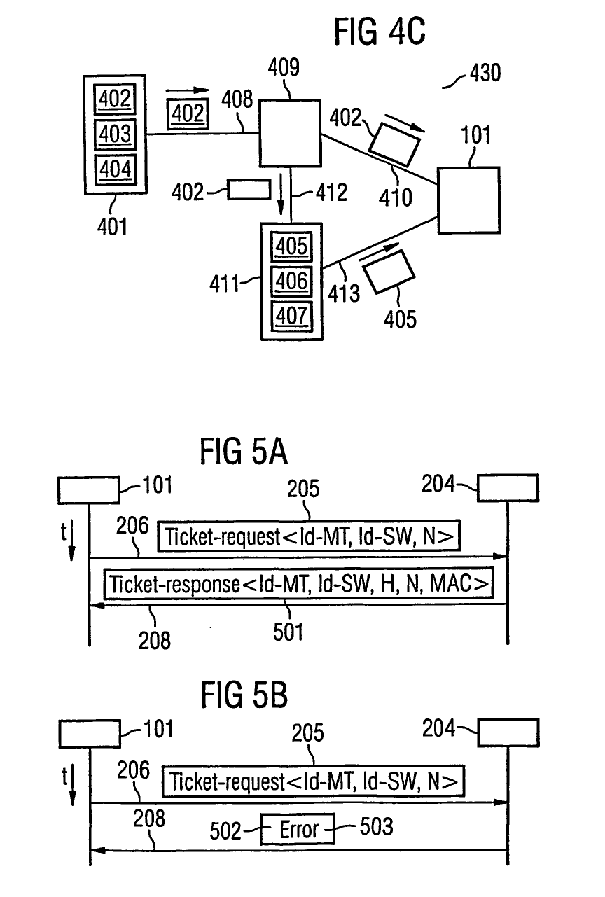

FIGS. 5a and 5b Message flow diagrams showing a case where in response to a request message an installation authorization message is transmitted that enables installation or execution of the program element (FIG. 5a) or with an installation authorization message that does not permit the installation or execution of the program element (see FIG. 5B).

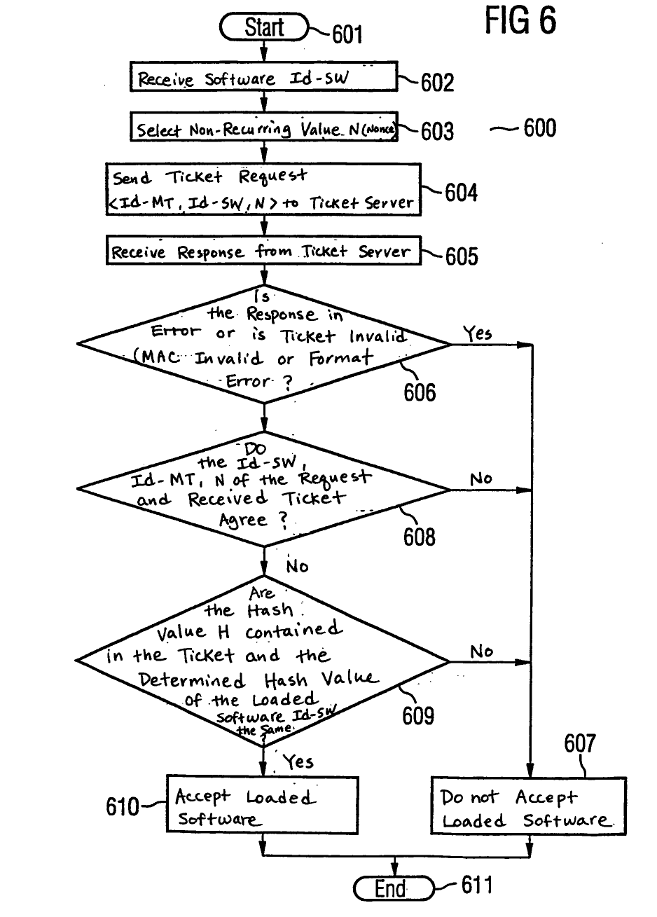

FIG. 6 A flow diagram in which the individual procedural steps that are performed in the mobile terminal in accordance with an exemplary embodiment of the invention are shown.

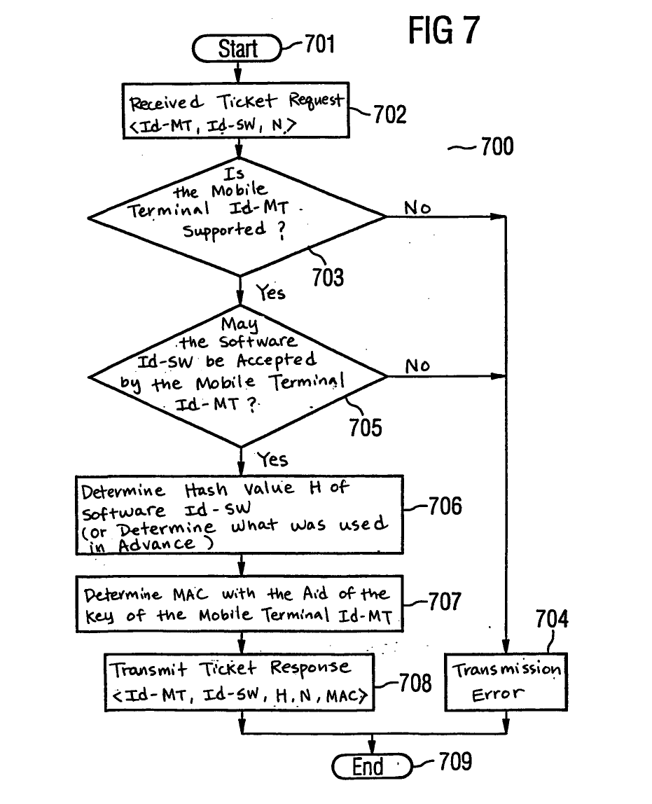

FIG. 7 A flow diagram in which the individual procedural steps that are performed in the authentication unit in accordance with an exemplary embodiment of the invention are shown.

FIG. 1 shows a communication system 100 with a number of mobile communication terminals 101, each of which is connected via an air interface 102, i.e. a radio link, with a Base Transceiving Station (BTS) 103, also referred to in the following as a base station, that in each case is assigned to a Base Station System (BSS) 104, with a Base Station Controller (BSC) 105 being provided for each base station system 104, for control of the base station(s) 103 contained in the base station system 104.

At least some of the base station systems 104 of the communication system 100 are connected in accordance with the GSM/GPRS/EDGE standard to a Mobile Switching Center (MSC) 106 for switching conducted voice or data as well as to a SGSN 107 (Serving GPRS Support Node) for transmitting packet data at a gateway (Gateway GPRS Support Node, GGSN) 108 in a packet data network 112. The mobile switching center 106 is connected to a conventional telephone network 109.

The switching center 106 or the SGSN 107 performs the functions necessary for switching communication connection for operation of the mobile communication terminals 101 in the particular group of base station systems 104, for which a mobile switching center 106 or the SGSN 107 is “responsible” in each case.

The main functions provided by the mobile switching center 106 or the SGSN 107 are as follows.

The routing and control of calls, i.e. communication connections.

Procedures for the interaction with other communication networks, for example a fixed network such as PSTN, ISDN.

Methods for updating the entries in the communication terminals while they are transferring from one mobile radio cell to another, etc.

Each base station 103 is connected via the packet data network 112 with a further authentication unit 110, explained in more detail in the following.

Furthermore, the communication system 100 has at least one program element preparation computer 111 connected to the mobile communication terminals 101, also via the packet data network 112.

FIG. 2 shows a simplified representation of the communication system 200 in accordance with a first exemplary embodiment of the invention.

A program element 202 is stored in a program element preparation computer 201 and is transmitted via a communication connection 203 from the program element preparation computer 201 to a mobile communication terminal and stored there in accordance with this exemplary embodiment of a mobile radio telephone 101.

As explained in more detail in the following, the mobile communication terminal 101 receives the program element 202 from a source that is not reliable for the mobile communication terminal 101.

Before the actual installation or execution of the program element 202, the mobile communication terminal 101 checks whether the program element is reliable and whether it may in fact be installed or executed.

To check whether the program element may be installed or whether it is unchanged and thus reliable, the mobile communication terminal 101 requests an installation authorization message from an authentication unit 204, that is further explained in the following.

This takes place by the transmission or a request message 205 from the mobile communication terminal 101 to the authentication unit 204 via a second communication link 206.

On the basis of the request message 205, it is determined in the authentication unit 204 whether or not the particular program element 202 may be installed or executed on the mobile communication terminal 101.

The result of the check is transmitted to the mobile communication terminal 101 by means of an installation authorization message 207 from the authentication unit 204 to the mobile communication terminal 101 via the communication link 206.

FIGS. 3a and 3b show alternative architectures of a communication system 300, 310 in accordance with further exemplary embodiments of the invention.

The program element 302 is stored in the program element preparation computer 301 (see FIG. 3a).

The program element 302 is transmitted from the program element preparation computer 301 via a first communication link 303 to the mobile communication terminal 101, in this exemplary embodiment at least partially by means of a radio link.

Furthermore, the program element 302 is transmitted via a second communication link 304 to the authentication unit 305, whereupon the authentication unit 305 on receipt of the program element 302, or alternatively after a receipt of a request message (not illustrated), forms an installation authorization message 306.

The installation authorization message 306 is transmitted in a further step via a third communication link 307, in accordance with this exemplary embodiment also a radio link, to the mobile communication terminal 101.

On the basis of the installation authorization message 306, a check is carried out in the communication terminal 101, as explained in more detail in the following, to determine whether the received program element 302 may be installed or executed.

FIG. 3b shows an alternative architecture where the authentication unit 305 is connected only to the program element preparation computer 301 via the second communication link 304 and not directly to the mobile communication terminal 101. In this case also, the installation authorization message 306 is formed on receipt of the program element 302, or alternatively after receipt of a request message (not illustrated).

In a further step, the installation authorization message 306 is transmitted via the second communication link 304 to the program element preparation computer 301 and from there on to the mobile communication terminal 101.

FIG. 4a to FIG. 4b show further alternatives of a communication system 400, 420, 430 in accordance with further exemplary embodiments of the invention.

According to an exemplary embodiment of the invention shown in FIG. 4a, an archive computer 401 is provided in which a number of program element 402, 403, . . . , 404 are stored.

Furthermore, a number of installation authorization messages 405, 406, . . . 407 are stored in the archive computer 401.

The archive computer 401 is connected via a first communication link 408 with the program element preparation computer 409.

The program element preparation computer 409 is connected to the mobile communication terminal 101 via a second communication link 401.

An optional program element 402, 403, 404 requested by the program element preparation computer 409 is transmitted from the archive computer 401 to the program element preparation computer 409, where it is temporarily buffer stored or permanently stored and transmitted via the third communication link 412 to the mobile communication terminal 101.

Furthermore, the particular installation authorization message 405, 406, 407 belonging to the program element 402, 403, 404 is transmitted via the first communication link 408 to the program element preparation computer 409, where it is also temporarily or permanently stored and transmitted onwards via the second communication link 410 to the mobile communication terminal 101.

FIG. 4b shows and alternative architecture with a number of installation authorization messages 405, 460, . . . 407 being stored in the archive computer 401.

The exemplary embodiment shown in FIG. 4b differs from the exemplary embodiment shown in FIG. 4a particularly in that, as in the exemplary embodiment in accordance with FIG. 3b, the authentication unit 411 is connected to the program element preparation computer 409 via a third communication link 412. After receipt of the program element 402, or alternatively after receipt of a request message (not illustrated), the installation authorization message 405, 406, 407 is formed.

In a further step, the installation authorization message 405 is transmitted via the third communication link 412 to the program element preparation computer 301 and from there transmitted onwards via the second communication link 412 to the mobile communication terminal 101.

The exemplary embodiment shown in FIG. 4c differs from the exemplary embodiment shown in FIG. 4b particularly in that, as in the exemplary embodiment in FIG. 3a, the authentication unit 411 is connected directly to the mobile communication terminal 101 via a fourth communication link 413. With this exemplary embodiment, the installation authorization message 405 is thus directly connected to the mobile communication terminal 101 via the fourth communication link 413.

The procedure described in the following, particularly the construction of the request message and the installation authorization message, is identical for all the exemplary embodiments described, in which the particular messages are used.

Therefore to simplify the representation of the invention, the procedure for preparing a program element described in the following uses the structure of the communication system 200 in accordance with the first exemplary embodiment.

As shown in FIG. 2, the program element 202 is transmitted from the program element preparation computer 201 via the first communication link 203 to the mobile communication terminal 101 and is stored there.

After receipt of the program element 202, the request message 205 is formed by the mobile communication terminal 101.

As shown in FIG. 5a and FIG. 5b, the request message 205 contains the following information.

A first piece of identification information with which the prepared program element is identified, in FIG. 5a designated as Id-SW.

A second piece of identification information with which the mobile communication terminal 101 is clearly identified. This is shown in FIG. 5a as Id-MT and

a non-occurring value; in accordance with this exemplary embodiment a random number N.

The random number N in accordance with this exemplary embodiment serves to provide a logic connection between the request message 205 and a first type of installation authorization message 501, described later.

If program element 202 is reliable and may be installed and executed on the mobile communication terminal 101, this first type of installation authorization message 501 transmitted from the authentication unit 204 to the mobile communication terminal 101 (see FIG. 5a), contains

also the first piece of identification information with which the prepared program element 202 is clearly identified, designated in FIG. 5a as Id-SW,

the second piece of identification information with which the mobile communication terminal 101 is clearly identified, designated in FIG. 5a with Id-MT,

a cryptographically strong hash value H, that was formed by means of the program element 202,

the random number N,

a checksum for the previously described data in the installation authorization message 501.

As an option, the following information can additionally be contained in the installation authorization message 501.

The time point of creation, i.e. of generation of the installation authorization message.

An indication of a time period during which the installation authorization method is reliable, i.e. valid.

An indication of the provider or distribution instance of the particular program element.

An indication of the safety domain to which the loaded, i.e. prepared program element should be assigned.

An indication of the authorizations that should be accorded to the program element during its execution by the second computer, in particular access rights to other wider program elements.

Indications of the resource requirement needed by the prepared program element for its execution and also for storage.

An indication that the program element is operable on a specified type (model) of a computer.

An indication that the program element is compatible with a further program element stored and operable on a second computer.

If the program element 202 is not reliable, i.e. may not be installed or executed on the mobile communication terminal 101, authentication unit 204 forms an installation authorization installation message of a second kind 502 containing a fault indication 503 and transmits this to the mobile communication terminal 101 (see FIG. 5b).

The request message 205 and/or the installation authorization message 501 are cryptographically secured by using a symmetrical cryptographic method.

The cryptographic strength of the hash value H, that has been formed by the program element 202, is, according to this exemplary embodiment, determined in accordance with the MD5 method or the SHA-1 method as a cryptographic checksum.

This information can be used to check that program element 202 is unchanged.

The checksum, designated as MAC in FIG. 5a, is formed by the data contained in the first type of installation authorization method 501, by using a secret symmetrical key known and stored only in the mobile communication terminal and authentication unit 204, for example by using a method for forming a message authentication code.

By use of the security information, referred to in the following as the cryptographic value, formed by using the symmetrical secret key, at least by using the first piece of identification information and the second piece of identification information, the installation authorization message 501 and information contained therein is protected in a simple and thus very efficient manner.

In this way, it is guaranteed that no unauthorized third party can generate an installation authorization message of the first type 501 that would be falsely accepted by the mobile communication terminal 101.

To create and distribute unambiguous secret symmetrical keys for a pair of mobile communication terminals 101 and authentication unit 204 in each case, any method for creating a symmetrical key and for distributing such a key in both units communicating with each other can in principle be used in the context of the invention.

FIG. 6 is a flow diagram 600 showing the individual method steps that are performed in the mobile communication terminal 101 in accordance with the first exemplary embodiment of the invention.

After the program is started in a first step 601, then, in a further step (step 602) as already described, the program element 202 is received in the mobile communication terminal 101. In addition, the first piece of identification information, i.e. the information for identification of program element 202, is received and stored in the mobile communication terminal 101.

In a further step (step 603), a random number N is formed. The request message 205 is then formed in a further step (step 604) by using the random number N, the first piece of identification information and the second piece of identification information, and is transmitted to the authentication unit 204.

After the request message 205 has been completely transmitted, the mobile communication terminal 101 goes to a waiting state and waits for the reception of an installation authorization message 501, 502, that is to be sent from the authentication unit 204.

FIG. 7 is a flow diagram 700 showing the individual method steps that are carried out in the authentication unit 204 in accordance with this exemplary embodiment of the invention.

After starting the procedure in a first step (step 701), a transition to a waiting state takes place in which the authentication unit 204 awaits the receipt of a request message that was sent from a mobile communication terminal 101.

If a request message 205 is received in a further step (step 702), a check is carried out in a first check step (step 703), by using the second piece of identification information, to determine whether the authentication unit 204 is in fact responsible for the mobile communication terminal 101 designed by the second piece of identification information, i.e. in other words whether the authentication unit 204 supports the mobile communication terminal 101.

If this is not the case, the second type of installation authorization message 502 is formed using a corresponding piece of error information 503 and transmitted to the mobile communication terminal 101 (step 704).

If the authentication unit 204 does however support the mobile communication terminal 101 identified by the second piece of identification information, a check is carried out in a second check step (step 705) by using the first piece of identification information to determine whether the program element designated by the first piece of identification information may be accepted by the particular mobile communication terminal 101.

If this is not the case, a second type of installation authorization message 502 is in turn formed in step 704 using a corresponding error message 503 and is transmitted to the mobile communication terminal 101.

If, however, program element 202 can be accepted, i.e. installed and executed, by the communication terminal 101, the authentication unit 204 then, in a further step (step 706) determines the cryptographic hash value H using the MD5 method or the SHA-1 method, or a stored cryptographic hash value that been specifically provided in advance for program element 202, is read or ascertained.

In a further step (step 707), a message authentication code is determined using the symmetrical secret key, that is known both by the authentication unit 204 and the mobile communication terminal 101.

In a further step (step 708) the first type of installation authorization message 501 is formed and transmitted to the mobile communication terminal 101.

After transmission of the first type 501 or second type 502 of installation authorization message (step 704 or 708), the procedure is terminated in the authentication unit 204 (step 709).

If the mobile communication terminal 101 receives the installation authorization message 501, 503 (step 605), a check is then carried out in a third check step (step 606) to determine whether the installation authorization message is an installation authorization message of the second type 502 or whether the checksum, i.e. the message authentication code, is invalid or whether a format error is present.

If this is the case, the loaded program element 202 is not accepted, i.e. not installed and also not executed (symbolized in FIG. 6 by block 607).

If the received installation authorization message is an installation authorization message of the first type 501 and the message authentication code MAC is valid and also no format error has been found, a check is then carried out in a fourth check step (step 608) to determine whether the first piece of identification information, the second piece of identification information and the random number, contained in the first type of installation authorization message 501, agrees with the particular first piece of identification information, second piece of identification information and the random number that was sent from the mobile communication terminal 101 in the request message 205 to the authentication unit 204.

If the first piece of identification information and/or the second piece of identification information and/or the random number in the installation authorization message 501 and the request message 206 do not agree, the loaded program element 202 is not accepted (block 607).

If the information in the request message 206 and in the installation authorization message 501 do, however, agree, a check is then carried out in a fifth check step (step 609) to determine whether the hash value H contained in the installation authorization message 501 and the hash value also determined by the mobile communication terminal 101 via the program element 202 agree. In this regard, it is to be noted that the algorithm used in the mobile communication terminal to form the hash value is the same as that in the authentication unit 204.

If the hash values are not the same, the loaded program element is again not accepted (block 607).

If, however, the hash values are the same, the loaded program element 202 is accepted (step 610), i.e. program element 202 is installed and executed.

After program element 202 has been accepted or not accepted (steps 610, 607) the procedure in the mobile communication terminal 101 is ended (step 611).

Some alternatives to the exemplary embodiment described above are explained in the following.

The sequence of the information both in the request message 206 and in the installation authorization message 501 can be flexibly changed.

Furthermore, the hash value H can already be contained in the request message 206. In this case, the first type of installation authorization message 501 merely confirms that the hash value H contained in request message 206 is correct. In this case, the check of the hash value H thus takes place in the authentication unit 204 and not in the mobile communication terminal 101.

It must also be pointed out that the use of a random number is optional and the random numbers used in the request message or in the first type of installation authorization message 501 can be different.

The request message 206 and/or the installation authorization message can additionally contain identification information for identifying the user of the mobile communication terminal 101 and/or for identification of the authentication unit 204.

Furthermore, several requests or installation authorization messages can be contained in a bundled request message or bundled installation authorization message and be transmitted together.

If the mobile communication terminal has contained no first type of installation authorization message 501, i.e. in other words if no first type of installation authorization message 501 or second type of installation authorization message 502 was received within a specified time period, i.e. after expiry of a timer, the check of the program element by means of a further request message can take place again from the mobile communication terminal 101, at a different authentication unit as an option. The reliability, particularly in the event of transmission error occurring or an authentication unit failing, can be further increased by this procedure.

A preset counter value can be used as an alternative to the random number.

An authentication unit can be provided that creates installation authorization messages, in principle for any number of providers of program elements. Furthermore, several authentication units can be contained in the communication system, that each create installation authorization messages for one or more providers of program elements and transmits them to the relevant mobile communication terminal.

As explained above, the authentication unit can be contained in a computer together with the program element preparation computer or the program element preparation computer, as an agent for the mobile communication terminal 101, can request an installation authorization message directly from the authentication unit and transmit the created installation authorization message to the mobile communication terminal together with the program element.

The creation of a first type of installation authorization message can, through the authentication unit, be made dependent on whether a license is present for the particular program element and whether the authentication unit is known.

Furthermore, it can be provided that a legal financial claim, for example a claim for compensation for the use of the loaded program element, can be based on a created first type of installation authorization message 501.

The additional information described above can be distributed over several installation authorization messages transmitted in succession.

With an alternative form of embodiment of this kind, it can be provided that the different installation authorization messages are requested by different authentication instances, and created and transmitted to the mobile communication terminal.

Clearly, the invention can be seen as enabling a safe loading of program elements, i.e. of software, even for a mobile communication terminal with limited performance capacity, i.e. with limited computing resources. For this purpose, the authentication instance is clearly provided as a ticket server that creates program element installation tickets, i.e. the installation authorization messages, that are valid only from the point of view of the authentication unit. These installation tickets are used to ensure that a mobile communication terminal accepts only valid software, i.e. only valid program elements.

1. Method for providing a program element from a first computer for a second computer,
with the program element being transmitted from the first computer to the second computer,
with an installation authorization message being transmitted to the second computer,
with the installation authorization message containing at least the following information:
a first piece of identification information by means of which the provided program element is identified;
a second piece of identification information by means of which the second computer is identified;
a cryptographic value for at least the first piece of identification information and the second piece of identification information;
with the cryptographic value being formed by using a symmetrical secret key, with said symmetrical secret key being available in the second computer and in an authentication unit,
with the cryptographic value being verified in the second computer by using the symmetrical secret key, and
it being determined in the second computer, by using the installation authorization message and the verified cryptographic value, whether the program element in the second computer may be installed or executed.

2. Method according to claim 1,
with the cryptographic value being a message authentication code.

3. Method according to claim 1 or 2,
with the cryptographic value being determined according to one of the following methods:
CBC-MAC by using a known block cipher, for example DES, 3DES, AES, IDEA,
HMAC by using a known hash function, for example MD5, SHA-1, RIPEMD, RIPEMD160, also designated as HMAC-MD5, HMAC-SHA1, HMAC-RIPEMD, HMAC-RIPEMD160,
HMAC by using a known hash function with a shortened output, for example, HMAC-MD5-80, HMAC-SHA1-80, HMAC-RIPEMD-80, HMAC-RIPEMD160-80 with an output shortened to 80 bits,
MAA,
RIPE-MAC,
MD5-MAC

4. Method in accordance with one of claims 1 to 3,
with at least one of the following pieces of information being contained in the installation authorization message.
The time point at which the installation authorization message was created.
A time indication which indicates how long the installation authorization message is valid.
A third piece of identification information for identifying the provider of the program element.
An indication of a security domain to which the provided program element is to be assigned.
Authorization information that is assigned to the program element and that is to be accorded to the program element during execution by the second computer.
An indication of the resources required by the provided program element.
An indication that the program element is operable on a specified type (model) of a computer.
An indication that the program element is compatible with a further program element that is stored and operable on a second computer.

5. Method in accordance with one of claims 1 to 4,
with a request message being transmitted from the second computer to the authentication unit, by means of which an installation authorization message for the program element provided in the second computer is requested,
with at least the first piece of identification information and the second piece of identification information being contained in the request message.

6. Method in accordance with one of claims 1 to 5,
with a first non-recurring value being contained in the installation authorization message.

7. Method in accordance with claim 5,
with a second non-recurring value being contained in the request message.

8. Method in accordance with claim 6 or 7,
with the first non-recurring value being the same as the second non-recurring value.

9. Method in accordance with one of claims 6 to 8,
with a random value or a counter value being used as the non-recurring value.

10. Method in accordance with one of claims 1 to 9,
with the authentication unit being contained in the first computer.

11. Method in accordance with one of claims 1 to 10,
with the second computer being a telecommunication terminal.

12. Method in accordance with claim 11,
with the second computer being a mobile telecommunication terminal.

13. Method in accordance with claim 11 or 12,
with the second computer being a mobile radio communication terminal.

14. Communication system for providing a program element,
with a first computer in which the program element is stored, with the first computer containing a transmitter unit for transmitting the program element to a second computer,
with the second computer, with the second computer containing a receiver unit for receiving the program element and an installation authorization message,
with the installation authorization message containing at least the following information:
a first piece of identification information by means of which the provided program element is identified,
a second piece of identification information with which the second computer is identified,
a cryptographic value of at least the first piece of identification information and the second piece of identification information,
with an authentication unit,
with a symmetrical secret key being stored in the second computer and in the authentication unit,
with the authentication unit have a unit for forming the cryptographic value by using the symmetrical secret key,
with the second computer having a verification unit for verification of the cryptographic value by using the symmetrical secret key, and
with the second computer being a decision unit set up in such a way that by using the installation authorization message and verified cryptographic value it is determined whether the program element in the second computer may be installed or executed.
